(19) United States
(12) Patent Application Publication
(10) Pub. No.: US 2025/0155099 A1
(43) Pub. Date: May 15, 2025

(54) OPTICAL ELEMENT, LIGHTING DEVICE AND VEHICLE

(71) Applicant: VALEO VISION, Bobigny (FR)

(72) Inventors: Xiaoyong ZHU, Bobigny (FR); Yagui GAO, Bobigny (FR); Sihua WU, Bobigny (FR); Haiqing ZHOU, Bobigny (FR)

(73) Assignee: VALEO VISION, Bobigny (FR)

(21) Appl. No.: 18/722,387

(22) PCT Filed: Dec. 16, 2022
(86) PCT No.: PCT/EP2022/086498

§ 371 Date: Jun. 20, 2024

(30) Foreign Application Priority Data
Dec. 23, 2021 (CN) 202111593433.9
Dec. 23, 2021 (CN) 202123270863.5

(51) Int. Cl. F21S 41/24; F21S 43/235; F21S 43/249

(52) U.S. Cl. CPC F21S 41/24; F21S 43/249; F21S 43/252

(57) ABSTRACT

The present invention relates to an optical element, for realizing a first light function and a second light function, the second light function being different from the first light function. The optical element includes at least one light source, a first light guide unit and a second light guide unit. The at least one light source being configured to emit light rays for the first light function and the second light function, and emit light rays at least towards the first light guide unit. The first light guide unit being arranged upstream of the second light guide unit in a main emergence direction of the optical element, and at least a portion of light from the first light guide unit emerges through the second light guide unit. The present invention also relates to a lighting device and a vehicle.

### TECHNICAL FIELD

The present invention relates to the technical field of vehicle lamps, in particular to an optical element, a lighting device and a vehicle.

### BACKGROUND OF THE INVENTION

Lighting devices are widely used in various fields to provide light rays for lighting and/or optical indication functions; for example, lighting devices such as vehicle lamps are used in motor vehicles to ensure safe travel. In motor vehicles, various types of vehicle lamps are often required to implement different functions, including the headlight, fog light, tail light, turn signal light, brake light, side marker light, parking light, etc.

Generally, vehicle lamps with different functions are disposed in different housing spaces; such a configuration not only increases the volume, weight and manufacturing cost of the vehicle lamps, but also increases the complexity of assembly work. Thus, more and more manufacturers propose integrating vehicle lamps having two or more functions in the same housing space; in this case, the optical path design becomes a major challenge.

### SUMMARY OF THE INVENTION

Thus, an objective of the present invention is to propose an optical element, a lighting device and a vehicle, which can at least partially solve the abovementioned problem.

According to one aspect of the present invention, an optical element is provided, for realizing a first light function and a second light function, the second light function being different from the first light function; the optical element comprises at least one light source, a first light guide unit and a second light guide unit, wherein:
the at least one light source is configured to emit light rays for the first light function and the second light function, and emit light rays at least towards the first light guide unit;
the first light guide unit is arranged upstream of the second light guide unit in a main emergence direction of the optical element, and at least a portion of light from the first light guide unit emerges through the second light guide unit. An advantage of designing the light paths in this way is that light rays used for the first light function and light rays used for the second light function have the same light output region, and the double use of the light output region enables the optical element to have a smaller volume and weight and a lower cost.

In some examples, the first light guide unit and the second light guide unit are plate-like light guides, and arranged in such a way as to be stacked one in front of the other in the main emergence direction. Thus, the optical element can have an illuminated appearance of surface light emission over a predetermined area.

In some embodiments, the first light guide unit and the second light guide unit extend substantially perpendicular to the main emergence direction.

In some embodiments, light rays from the at least one light source enter through an end face of the first light guide unit, propagate between a front-side surface and a rear-side surface of the first light guide unit, and emerge from the front-side surface of the first light guide unit. This configuration enables the optical element to have a smaller dimension in the main emergence direction, and achieve a more uniform illumination effect.

In some embodiments, scattering particles are included inside the first light guide unit, the scattering particles being configured to scatter light rays from the at least one light source. Such a light guide unit with scattering particles has very good light diffusion properties, so can achieve a very uniform light illumination effect.

In some embodiments, the rear-side surface of the first light guide unit comprises optical decoupling elements, the optical decoupling elements being configured to cause light rays from the at least one light source to emerge from a front-side surface of the first light guide unit. The optical decoupling element can destroy the conditions for total reflection of light rays in the first light guide unit, so that the light rays emerge.

In some embodiments, at least a portion of the rear-side surface of the first light guide unit is inclined towards the front-side surface of the first light guide unit, to reflect light rays from the at least one light source towards the front-side surface of the first light guide unit. Preferably, the rear-side surface of the first light guide unit comprises multiple totally reflecting small faces configured to totally reflect light rays from the at least one light source towards the front-side surface of the first light guide unit. Thus, the uniformity of the illumination effect can be increased while increasing the optical efficiency.

In some embodiments, the optical element further comprises a reflective layer, the reflective layer being arranged upstream of the first light guide unit in the main emergence direction, to reflect light from the first light guide unit towards the second light guide unit. The reflective layer can improve optical efficiency.

In some embodiments, the optical element further comprises a scattering layer, the scattering layer being arranged between the first light guide unit and the second light guide unit, to scatter light from the first light guide unit. The scattering layer can further improve the uniformity of the illumination effect.

In some embodiments, the scattering layer is integrated with the first light guide unit and/or the second light guide unit. In this way, processing can be simplified and the overall thickness of the optical element can be reduced.

In some embodiments, the at least one light source comprises:
a first light source, wherein light of the first light source enters through the end face of the first light guide unit; and
a second light source, wherein light of the second light source enters through an end face of the second light guide unit, propagates between a front-side surface and a rear-side surface of the second light guide unit, and emerges from the front-side surface of the second light guide unit.

In some embodiments, scattering particles are included inside the second light guide unit, the scattering particles being configured to scatter light rays from the second light source. Such a light guide unit with scattering particles has very good light diffusion properties, so can achieve a very uniform light illumination effect.

In some embodiments, the rear-side surface of the second light guide unit comprises optical decoupling elements, which are configured to cause light rays from the second light source to emerge from the front-side surface of the second light guide unit. The optical decoupling element can destroy the conditions for total reflection in the second light guide unit, so that the light rays emerge.

In some embodiments, the at least one light source only comprises a first light source, the first light source emitting light rays towards the first light guide unit, and the second light guide unit only transmits light rays from the first light guide unit.

In some embodiments, the optical element further comprises a holder; and the at least one light source, the first light guide unit and the second light guide unit are held by the holder.

In some embodiments, the holder at least partially surrounds peripheral outer edges of the first light guide unit and the second light guide unit. Undesired light leakage can thereby be prevented.

In some embodiments, the holder comprises a first holder and a second holder, the first light guide unit and the second light guide unit being clamped between the first holder and the second holder.

In some embodiments, a reflective layer is provided on a side of the first holder facing the first light guide unit, to reflect light from the first light guide unit towards the second light guide unit. The reflective layer can improve optical efficiency.

In some embodiments, the second holder does not extend beyond the second light guide unit in the main emergence direction. Such a height configuration can reduce the overall thickness of the optical element, and can also weaken the visual presence of the second holder when the optical element is not illuminated, improving the appearance of the optical element.

According to another aspect of the present invention, a lighting device is further provided, comprising any one of the optical elements described above.

According to another aspect of the present invention, a vehicle is further provided, comprising the abovementioned lighting device.

### BRIEF DESCRIPTION OF DRAWINGS

The abovementioned characteristics, technical features, advantages and modes of implementation of the present invention are explained further below in a clear and easy-to-understand manner by giving a description of preferred embodiments with reference to the drawings, wherein

FIG. 1 shows a front view of an optical element 10 according to an embodiment of the present invention.

FIG. 2 shows a rear view of the optical element 10 in FIG. 1.

FIG. 3 shows a sectional view, along line A-A, of the optical element 10 according to a first embodiment of the present invention in FIG. 1.

FIG. 4 shows a sectional view, along line A-A, of the optical element 10 according to a second embodiment of the present invention in FIG. 1.

FIG. 5 shows a sectional view of a first light guide unit 200 according to an embodiment of the present invention.

FIG. 6 shows an exploded schematic drawing of the optical element 10 according to an embodiment of the present invention in FIG. 1.

### DETAILED DESCRIPTION OF THE INVENTION

Embodiments of the present invention are described demonstratively below. As those skilled in the art should realize, the embodiments described may be amended in various ways without departing from the concept of the present invention. Thus, the drawings and description are essentially illustrative, not restrictive. In the following text, identical reference numerals generally denote elements with identical or similar functions.

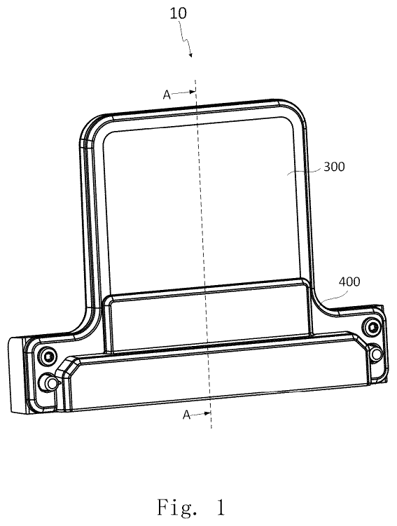

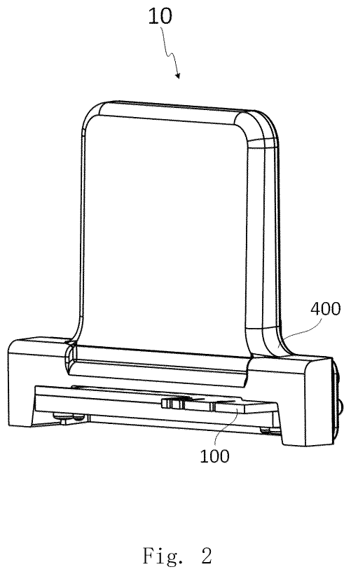

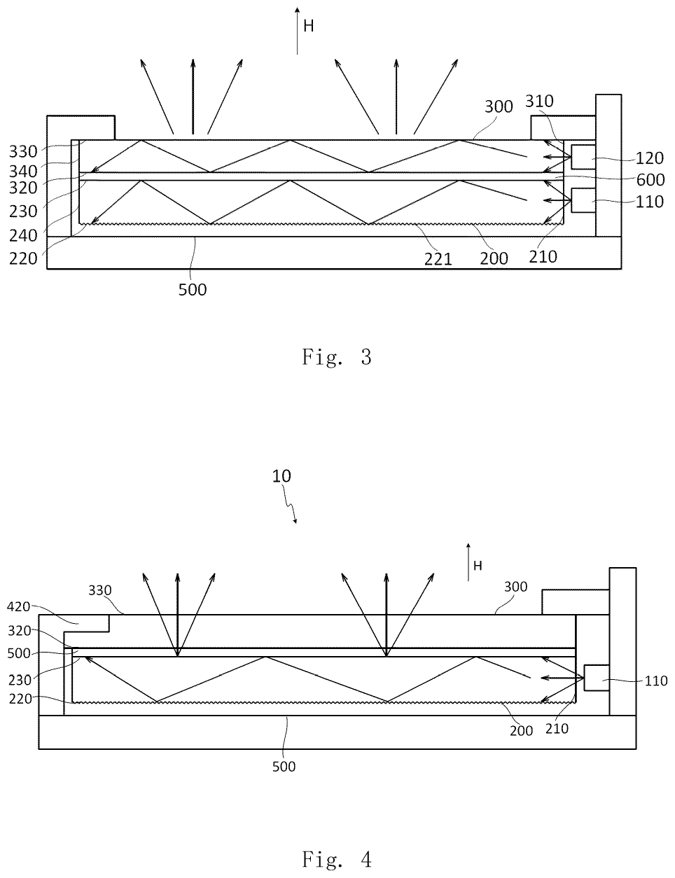

FIG. 1 shows a front view of an optical element 10 according to an embodiment of the present invention; FIG. 2 shows a rear view of the optical element 10 in FIG. 1; FIG. 3 shows a sectional view, along line A-A, of the optical element 10 according to a first embodiment of the present invention in FIG. 1; FIG. 4 shows a sectional view, along line A-A, of the optical element 10 according to a second embodiment of the present invention in FIG. 1. The optical element 10 according to an embodiment of the present invention may be used to realize a first light function and a second light function, wherein the second light function is different from the first light function, and each of the first light function and second light function may comprise one or more of a turn signal light function, a brake light function, a side marker light function, a parking light function, a daytime running light function, a position light function and a grille light function, etc. As a non-limiting example, the first light function may comprise a brake light function, and the second light function may comprise a turn signal light function. It must be explained that examples of the first light function and second light function are not limited to this, and may also include any suitable lighting and/or signal indicating function.

As shown in FIGS. 1-4, the optical element 10 comprises a printed circuit board (PCB) 100, a first light guide unit 200, a second light guide unit 300 and a holder 400, wherein at least one light source is mounted on the PCB 100, the at least one light source emitting light rays for the first light function and second light function, and emitting light rays at least towards the first light guide unit 200; the holder 400 holds the PCB 100, the first light guide unit 200 and the second light guide unit 300, and the specific manner of holding will be described below with reference to FIG. 6.

In the present invention, two embodiments of the optical element 10 will be presented in detail. These two embodiments both have the front appearance and rear appearance shown in FIGS. 1 and 2, but differ in terms of whether the at least one light source emits light rays towards the second light guide unit 300. Specifically, a first embodiment of the optical element 10 has the sectional schematic drawing shown in FIG. 3, and a second embodiment of the optical element 10 has the sectional schematic drawing shown in FIG. 4. In FIGS. 3 and 4, H represents a main emergence direction of the optical element 10. In both embodiments, the first light guide unit 200 is arranged upstream of the second light guide unit 300 in the main emergence direction H, and at least a portion of light from the first light guide unit 200 emerges via the second light guide unit 300; that is to say, light rays from the at least one light source will ultimately emerge from the second light guide unit 300. An advantage of designing the light paths in this way is that light rays used for the first light function and light rays used for the second light function have the same light output region, and the double use of the light output region enables the optical element to have a smaller volume and weight and a lower cost.

In one example, the first light guide unit 200 and the second light guide unit 300 are plate-like light guides, and arranged in such a way as to be stacked one in front of the other in the main emergence direction H, i.e. at least part of the first light guide unit 200 overlaps at least part of the second light guide unit 300. Thus, the optical element 10 can have an illuminated appearance of surface light emission over a predetermined area. It will be understood that examples of the first light guide unit 200 and second light guide unit 300 are not limited to plate-like light guides, and may also be light guides of any other suitable type.

In one example, the first light guide unit 200 and the second light guide unit 300 extend substantially perpendicular to the main emergence direction H, i.e. the first light guide unit 200 and the second light guide unit 300 extend substantially parallel to each other.

Two embodiments of the optical element 10 are described in detail below with reference to FIGS. 3 and 4.

As shown in FIG. 3, in a first embodiment of the optical element 10, the at least one light source comprises a first light source 110 and a second light source 120, wherein the first light source 110 emits light rays towards the first light guide unit 200, the second light source 120 emits light rays towards the second light guide unit 300, and at least a portion of light rays from the first light source 110 and the second light source 120 finally emerge from a front-side surface 330 of the second light guide unit 300 in the main emergence direction H. In one example, when implementing the first light function, the first light source 110 is switched on and the second light source 120 is switched off; when implementing the second light function, the second light source 120 is switched on and the first light source 110 is switched off. In another example, when implementing one of the first light function and the second light function, the light source corresponding to said one function is switched on and the other light source is switched off; when implementing the other of the first light function and the second light function, the first light source 110 and the second light source 120 are both switched on.

As shown in FIG. 3, the first light guide unit 100 comprises a front-side surface 230 and a rear-side surface 220 in the main emergence direction H, and an end face 210 connecting the front-side surface 230 and the rear-side surface 220. Light rays emitted by the first light source 110 enter the first light guide unit 200 through the end face 210, and propagate between the front-side surface 230 and rear-side surface 220 of the first light guide unit 200 towards another end face 240; during this time, at least a portion of the light rays emerge from the front-side surface 230 of the first light guide unit 200.

In one example, light rays from the first light source 110 propagate by total reflection after entering the first light guide unit 200. To enable at least a portion of the light rays to emerge from the front-side surface 230 of the first light guide unit 200, as shown in FIG. 3, optical decoupling elements 221 are provided on the rear-side surface 220 of the first light guide unit 200, to destroy the conditions for total reflection of light rays. Examples of optical decoupling elements include but are not limited to protrusions, depressions, sawteeth, skin patterns, etc.

In another example, scattering particles are included inside the first light guide unit 200, and these are likewise able to destroy the conditions for total reflection of light rays between the front-side surface 230 and rear-side surface 220. After entering the first light guide unit 200, light rays from the first light source 110 are scattered in different directions by the scattering particles, such that at least a portion of the light rays emerge from the front-side surface 230 of the first light guide unit 200. Such a light guide unit with scattering particles has very good light diffusion properties, so can achieve a very uniform light illumination effect. As a non-limiting example, a light guide unit of this type may employ a light guide of material poly(methyl methacrylate) (PMMA) and brand name LED 8N LD12, LD24, LD48 or LD96, or may employ a light guide of material polycarbonate (PC) and brand name EL2245; the color thereof may be chosen according to requirements, for example but without limitation, colorless, pale red, red, etc., wherein a colorless light guide has the best illumination uniformity, a pale red light guide has the next best illumination uniformity, and a red light guide has weaker illumination uniformity.

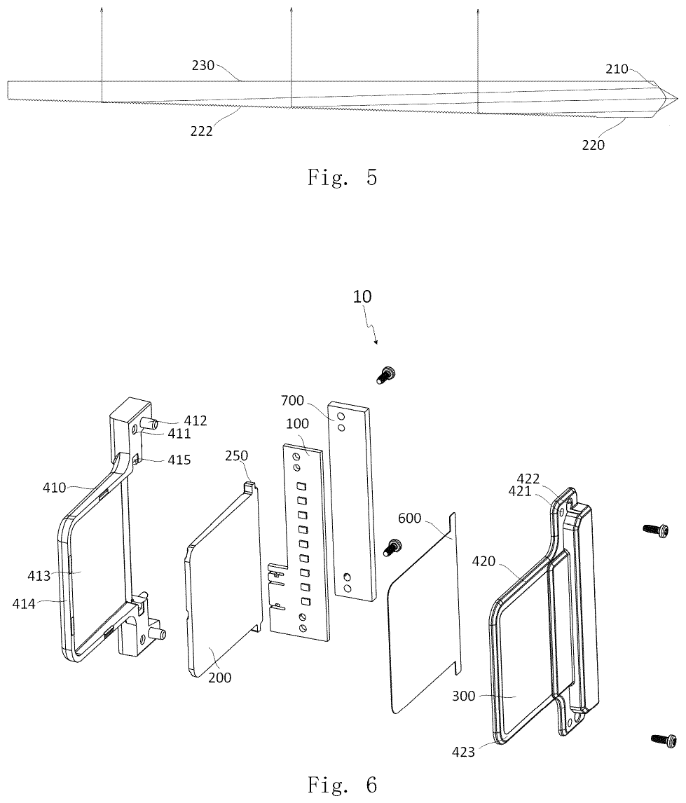

In another example, as shown in FIG. 5, at least a portion of the rear-side surface 220 of the first light guide unit 200 is inclined towards the front-side surface 230 of the first light guide unit 200; after reaching the rear-side surface 220, light rays entering through the end face 210 of the first light guide unit 200 are reflected towards the front-side surface 230, and thus emerge through the front-side surface 230. Preferably, the end face 210 of the first light guide unit 200 is provided with a collimator, for collimating light rays from the first light source 110, so that they are incident on the rear-side surface 220 of the first light guide unit 200 substantially in parallel. Furthermore, as shown in FIG. 5, the rear-side surface 220 of the first light guide unit 200 comprises multiple totally reflecting small faces 222, the totally reflecting small faces 222 being configured to totally reflect light from the first light source 110 towards the front-side surface 230 of the first light guide unit 200. Thus, the uniformity of the illumination effect can be increased while increasing the optical efficiency.

In the three examples of the first light guide unit 200 above, the configurations of the optical decoupling elements, the scattering particles, the collimator and the totally reflecting small faces are all capable of achieving a uniform illumination effect of surface light emission, and can greatly reduce costs compared with technical solutions that use OLEDs for example to achieve surface light emission.

As shown in FIG. 3, the second light guide unit 300 comprises a front-side surface 330 and a rear-side surface 320 in the main emergence direction H, and an end face 310 connecting the front-side surface 330 and the rear-side surface 320. Light rays emitted by the second light source 120 enter the second light guide unit 300 through the end face 310, and propagate between the front-side surface 330 and rear-side surface 320 of the second light guide unit 300 towards another end face 340; during this time, at least a portion of the light rays emerge from the front-side surface 330 of the second light guide unit 300. Furthermore, light rays from the first light guide unit 200 enter the second light guide unit 300 through the rear-side surface 320 of the second light guide unit 300, and emerge from the front-side surface 330 of the second light guide unit 300.

Just as with the first light guide unit 200, to enable at least a portion of light rays from the second light source 120 to emerge from the front-side surface 330 of the second light guide unit 300, optical decoupling elements may be provided on the rear-side surface 320 of the second light guide unit 300, and scattering particles may also be provided inside the second light guide unit 300. Specifically, the description relating to the first light guide unit 200 above is applicable, and is not repeated here. In the second light guide unit 300, the configurations of the optical decoupling elements and the scattering particles are both capable of achieving a uniform illumination effect of surface light emission, and can greatly reduce costs compared with technical solutions that use OLEDs for example to achieve surface light emission.

As shown in FIG. 3, the optical element 10 further comprises a reflective layer 500, which is arranged upstream of the first light guide unit 200 in the main emergence direction H. Light rays emerging from the rear-side surface 220 of the first light guide unit 200 can reach the reflective layer 500, and thereby be reflected by the reflective layer 500 towards the second light guide unit 300. In this way, the optical efficiency can be increased. In one example, the reflective layer 500 may be disposed on an inner side of the holder 400 facing the first light guide unit 200. The color of the reflective layer 500 may also be chosen according to requirements. For example but without limitation, if it is desired that the first light guide unit 200 should have a red appearance when not illuminated, in one example a red first light guide unit 200 and a white reflective layer 500 are chosen, and in another example a pale red first light guide unit 200 and a red reflective layer 500 are chosen, wherein the latter example has better illumination uniformity.

As shown in FIG. 3, the optical element 10 further comprises a scattering layer 600, arranged between the first light guide unit 200 and the second light guide unit 300. Light rays from the first light guide unit 200 are incident on the scattering layer 600 from a rear-side surface of the scattering layer 600, and are uniformly diffused by the scattering layer 600. In this way, the uniformity of the illumination effect can be further improved. The scattering layer 600 may be made of any suitable light-permeable scattering material, for example but without limitation, poly(methyl methacrylate) (PMMA), polycarbonate (PC), etc. Preferably, the scattering layer 600 may be integrated with the first light guide unit 200 and/or the second light guide unit 300, for example but without limitation, by an injection molding process (secondary injection molding, in-mold injection molding, etc.) or a spray-coating process. In this way, processing can be simplified and the overall thickness of the optical element 10 can be reduced.

Furthermore, although the first light source 110 and second light source 120 are shown in FIG. 3 as inputting light through only one end face of the first light guide unit 200 and one end face of the second light guide unit 300, it will be understood that the light sources may also input light simultaneously through two opposite end faces of the first light guide unit 200 and two opposite end faces of the second light guide unit 300, and moreover, the first light source 110 may comprise multiple light sources disposed along an end face of the first light guide unit 200, and the second light source 120 may comprise multiple light sources disposed along an end face of the second light guide unit 300.

As shown in FIG. 4, in the second embodiment of the optical element 10, the at least one light source only comprises the first light source 110, wherein the first light source 110 emits light rays towards the first light guide unit 200, the light rays from the first light source 110 propagate in the first light guide unit 200 and can emerge from the front-side surface 230 thereof, and then enter the second light guide unit 300 through the rear-side surface 320 of the second light guide unit 300, finally emerging from the front-side surface 330 of the second light guide unit 300. That is to say, in this embodiment, the second light guide unit 300 does not receive light rays from the light source directly, merely being used to transmit light rays from the first light guide unit 200. Thus, in this case, the second light guide unit 300 need only be made of a transparent material, for example but without limitation, poly(methyl methacrylate) (PMMA), polycarbonate (PC), etc., and the color thereof may be chosen according to requirements, for example but without limitation, colorless (e.g. if the scattering layer 600 is itself colored), red, amber, etc. Retaining the second light guide unit 300 can improve the appearance of the optical element, especially if the scattering layer 600 is also arranged between the first light guide unit 200 and the second light guide unit 300, and the second light guide unit 300 can also protect the scattering layer 600.

Furthermore, in this embodiment, the first light source 110 is used for both the first light function and the second light function. In one example, the first light source 110 may comprise multiple light sources disposed along an end face of the first light guide unit 200, which are able to emit light rays of two colors and/or two strengths, for the first light function and second light function respectively. In another example, the first light source 110 may comprise two light sources spaced apart along an end face of the first light guide unit 200, one light source emitting light rays for the first light function, and the other light source emitting light rays for the second light function.

Since the second embodiment and the first embodiment differ only with regard to the second light guide unit 300, the above description may be referred to for details of the first light guide unit 200, and is not repeated here; similarly, the above descriptions may be referred to for details of the reflective layer 500 and scattering layer 600.

The holding of the PCB 100, the first light guide unit 200 and the second light guide unit 300 by the holder 400 is described below with reference to FIG. 6. FIG. 6 shows an exploded schematic drawing of the optical element 10 according to an embodiment of the present invention in FIG. 1. As shown in FIG. 6, the holder 400 comprises a first holder 410 and a second holder 420, which are fitted together to clamp the first light guide unit 200 and second light guide unit 400 in the middle. Specifically, bolt holes 411 and 421 are provided on the first holder 410 and second holder 420 respectively, and bolts pass through the two bolt holes and thereby fixedly connect the two holders together. Optionally, the first holder 410 and second holder 420 further comprise a pre-positioning mechanism, for example but without limitation, a positioning post 412 on the first holder 410 and a positioning hole 422 in the second holder 20 as shown in FIG. 6. It will be understood that the first holder 410 and second holder 420 may also be connected together by another fixing method.

As shown in FIG. 6, the first holder 410 comprises a body part 413 and an edge part 414 extending from the body part 413 towards the first light guide unit 200. The first light guide unit 200 is accommodated in an accommodating space formed by the body part 413 and the edge part 414, and the course of the edge part 414 matches the course of a peripheral outer edge of the first light guide unit 200, such that the edge part 414 can at least partially surround the peripheral outer edge of the first light guide unit 200, thereby preventing undesired light leakage at the peripheral outer edge of the first light guide unit 200. Furthermore, the abovementioned reflective layer 500 may be formed at an inner side of the body part 413 facing the first light guide unit 200.

A positioning mechanism for the first light guide unit 200 is included on the first light guide unit 200 and the first holder 410. For example but without limitation, a lug 250 is included on the first light guide unit 200, and a slot 415 is included on the first holder 410, wherein the lug 250 may be engaged in the slot 415 to achieve pre-fixing of the first light guide unit 200. Once the first light guide unit 200 and the second light guide unit 300 have been fitted together, the first light guide unit 200 may be firmly clamped in the middle.

In the example shown in FIG. 6, the second light guide unit 300 is integrated with the second holder 420 by an injection molding process, and an edge part 423 of the second holder 420 at least partially surrounds a peripheral outer edge of the second light guide unit 300, preventing undesired light leakage while protecting the second light guide unit 300. It will be understood that the second light guide unit 300 may also be formed separately from the second holder 420, and fixed to the second holder 420 by another method, for example but without limitation, by a fixing method similar to that used for the first light guide unit 200.

In addition, as shown in FIGS. 4 and 6, the second holder 420 does not extend beyond the second light guide unit 300 in the main emergence direction H. That is to say, the second holder 420 is level with the second light guide unit 300 or has a lower height than the second light guide unit 300. Such a height configuration can reduce the overall thickness of the optical element, and can also weaken the visual presence of the second holder 420 when the optical element is not illuminated, improving the appearance of the optical element.

As shown in FIG. 6, the PCB 100 may be fixed to the first holder 410 and/or the second holder 420 by bolt fixing. In addition, the optical element 10 may also comprise a heat sink 700, and the PCB 100 may be fixed to the heat sink 700 by bolt fixing. However, the embodiments of the present invention are not limited to this; the PCB 100, the heat sink 400 and the holder 400 may be fixed together by any other suitable method.

According to an embodiment of the present invention, a lighting device is also included, which comprises any one of the optical elements described above.

According to an embodiment of the present invention, a vehicle is also included, which comprises a lighting device as described above.

The present invention is not limited to the structure described above; various other variants could also be used. Although the present invention has already been described by means of a limited number of embodiments, those skilled in the art could, drawing benefit from this disclosure, design other embodiments which do not depart from the scope of protection of the present invention disclosed herein. Thus, the scope of protection of the present invention should be defined by the attached claims alone.

What is claimed is:

1. An optical element for realizing a first light function and a second light function, the second light function being different from the first light function, the optical element comprises at least one light source, a first light guide unit and a second light guide unit, wherein:
the at least one light source is configured to emit light rays for the first light function and the second light function, and emit light rays at least towards the first light guide unit;
the first light guide unit is arranged upstream of the second light guide unit in a main emergence direction of the optical element, and at least a portion of light from the first light guide unit emerges through the second light guide unit.

2. The optical element according to claim 1, wherein the first light guide unit and the second light guide unit are plate-like light guides, and arranged in such a way as to be stacked one in front of the other in the main emergence direction.

3. The optical element according to claim 2, wherein the first light guide unit and the second light guide unit extend substantially perpendicular to the main emergence direction.

4. The optical element according to claim 1, wherein the first light guide unit is configured such that light rays from the at least one light source are incident on an end face of the first light guide unit, light rays from the at least one light source propagate between a front-side surface and a rear-side surface of the first light guide unit, and light rays from the at least one light source emerge from the front-side surface of the first light guide unit.

5. The optical element according to claim 4, wherein scattering particles are included inside the first light guide unit, the scattering particles being configured to scatter light rays from the at least one light source.

6. The optical element according to claim 4, wherein the rear-side surface of the first light guide unit includes optical decoupling elements, the optical decoupling elements being configured to cause light rays from the at least one light source to emerge from a front-side surface of the first light guide unit.

7. The optical element according to claim 4, wherein at least a portion of the rear-side surface of the first light guide unit is inclined towards the front-side surface of the first light guide unit, to reflect light rays from the at least one light source towards the front-side surface of the first light guide unit.

8. The optical element according to claim 7, wherein the rear-side surface of the first light guide unit includes multiple totally reflecting small faces configured to totally reflect light rays from the at least one light source towards the front-side surface of the first light guide unit.

9. The optical element according to claim 4, further comprising a reflective layer, the reflective layer being arranged upstream of the first light guide unit in the main emergence direction, to reflect light from the first light guide unit towards the second light guide unit.

10. The optical element according to claim 4, further comprising a scattering layer, the scattering layer being arranged between the first light guide unit and the second light guide unit, to scatter light from the first light guide unit.

11. The optical element according to claim 10, wherein the scattering layer is integrated with the first light guide unit and/or the second light guide unit.

12. The optical element according to claim 4, wherein the at least one light source includes:
a first light source, wherein light of the first light source enters through the end face of the first light guide unit; and
a second light source, wherein light of the second light source enters through an end face of the second light guide unit, propagates between a front-side surface and a rear-side surface of the second light guide unit, and emerges from the front-side surface of the second light guide unit.

13. The optical element according to claim 12, wherein scattering particles are included inside the second light guide unit, the scattering particles being configured to scatter light rays from the second light source.

14. The optical element according to claim 12, wherein the rear-side surface of the second light guide unit includes optical decoupling elements, which are configured to cause light rays from the second light source to emerge from the front-side surface of the second light guide unit.

15. The optical element according to claim 4, wherein the at least one light source only comprises a first light source, the first light source emitting light rays towards the first light guide unit, and the second light guide unit only transmits light rays from the first light guide unit.

16. The optical element according to claim 1, further comprising a holder, with the at least one light source, the first light guide unit and the second light guide unit being held by the holder.

17. The optical element according to claim 16, wherein the holder at least partially surrounds peripheral outer edges of the first light guide unit and the second light guide unit.

18. The optical element according to claim 16, wherein the holder includes a first holder and a second holder, the first light guide unit and the second light guide unit being clamped between the first holder and the second holder.

19. The optical element according to claim 18, wherein a reflective layer is provided on a side of the first holder facing the first light guide unit, to reflect light from the first light guide unit-towards the second light guide unit.

20. The optical element according to claim 18, wherein the second holder does not extend beyond the second light guide unit in the main emergence direction.

21.-22. (canceled)
